(19) United States
(12) Patent Application Publication
(10) Pub. No.: US 2014/0379171 A1
(43) Pub. Date: Dec. 25, 2014

(54) APPARATUS AND METHOD FOR CONTROLLING VEHICLE

(71) Applicant: HYUNDAI MOTOR COMPANY, Seoul (KR)

(72) Inventors: Si Jun Kim, Seoul (KR); Chul Min Kim, Suwon (KR); Jae Am Seo, Seongnam (KR)

(73) Assignee: HYUNDAI MOTOR COMPANY, Seoul (KR)

(21) Appl. No.: 14/050,649

(22) Filed: Oct. 10, 2013

(30) Foreign Application Priority Data
Jun. 25, 2013 (KR) 10-2013-0073133

(51) Int. Cl. G07C 5/00

(52) U.S. Cl. CPC G07C 5/008
USPC 701/2

(57) ABSTRACT

A system and method for controlling a vehicle are provided and include a server that is executed by a controller to analyze data collected from the vehicle during driving in real time to manage a driving pattern for the vehicle. In addition, the server provides to the vehicle control data that corresponds to the driving pattern of the vehicle when a control event for the vehicle occurs.

### CROSS-REFERENCE TO RELATED APPLICATION

This application is based on and claims priority from Korean Patent Application No. 10-2013-0073133, filed on Jun. 25, 2013 in the Korean Intellectual Property Office, the disclosure of which is incorporated herein in its entirety by reference.

### BACKGROUND

1. Field of the Invention

The present invention relates to an apparatus and method for controlling a vehicle, and more particularly, to a technology that analyzes a significant amount of data for the vehicle in a server and controls the vehicle by individual data.

2. Description of the Prior Art

To control a vehicle drivers driving the vehicle have different driving patterns. However, to continuously manage the driving pattern for a corresponding vehicle, the data needs to be analyzed. The vehicle may autonomously mange the driving pattern of the vehicle and a need for operations that detect an intention and characteristics of the driver through the driving pattern and implements the detected result to control the vehicle in real time has increased.

### SUMMARY

Accordingly, the present invention provides an apparatus and method for controlling a vehicle that manages a significant amount of data by analyzing data collected from vehicles in a server to manage a driving pattern that corresponds to each vehicle.

In addition, the present invention provides an apparatus and method for controlling a vehicle that automatically controls a corresponding vehicle based on a control parameter value by extracting and providing the control parameter value that corresponds to a driving pattern of the corresponding vehicle from a server when a control event occurs in the corresponding vehicle.

In one aspect of the present invention, an apparatus for controlling a vehicle may include: a data collecting unit that collects data from the vehicle and a surrounding environment of the vehicle; a communication unit that transmits the collected data to a server and receives, from the server, control data that corresponds to a driving pattern generated based on the collected data when a control event occurs; a parameter setting unit that sets a control parameter value for a corresponding mode of the vehicle based on the control data; and a module driving unit that operates a module driving of the vehicle based on the control parameter value.

The control data may include information regarding an operation mode and the control parameter value that corresponds to the operation mode. The parameter setting unit may be configured to change a basic setting value of a corresponding mode based on the control parameter value included in the control data, when the control data is control data of a mode which is not currently driven. The parameter setting unit may be configured to adjust a setting value of a module which is currently driven based on the control parameter value included in the control data, when the control data is control data of a mode which is currently driven. In addition, the collected data may be multimedia vehicle information that includes map data and at least one of controller area network (CAN) data and sensor data of the vehicle.

In another aspect of the present invention, a system for controlling a vehicle, may include: a vehicle that provides data collected during driving, in real time; and a server that analyzes the collected data from the vehicle to manage a driving pattern for the vehicle and provides control data that corresponds to the driving pattern of the vehicle to the vehicle when a control event for the vehicle occurs, wherein the vehicle sets a control parameter value of the vehicle based on the control data from the server and operates a driving of the vehicle according to the set control parameter value.

The server may include: a data analyzing unit that analyzes the collected data from the vehicle to determine a driving pattern for the corresponding vehicle; a control parameter determining unit that determines a control parameter value that corresponds to the driving pattern; and a server controlling unit that compares the collected data of the vehicle with the driving pattern determined for the corresponding vehicle to determine whether a control event occurs and provides the control data including the control parameter value to the vehicle when the control event for the vehicle occurs.

Further, the server controlling unit may provide the control parameter value that corresponds to a changed driving pattern of a corresponding mode to the vehicle when a driving pattern of a specific mode for the vehicle is changed as a result of analyzing the collected data. The vehicle may change a basic setting value of the corresponding mode based on the control parameter value. The server controlling unit may provide the control parameter value that corresponds to the driving pattern to the vehicle to operate the vehicle when a current control pattern of the vehicle is deviated from the driving pattern of the vehicle by a reference value or greater. The vehicle may adjust a setting value of a module which is currently driven based on the control parameter value.

### BRIEF DESCRIPTION OF THE DRAWINGS

The above and other objects, features and advantages of the present invention will be more apparent from the following detailed description taken in conjunction with the accompanying drawings, in which:

FIG. 1 is an exemplary diagram showing a configuration of a system for controlling a vehicle according to an exemplary embodiment of the present invention;

FIG. 2 is an exemplary block diagram showing a configuration of an apparatus for controlling a vehicle according to an exemplary embodiment of the present invention;

FIG. 3 is an exemplary illustration diagram showing a detail configuration of a data collecting unit of FIG. 2 according to an exemplary embodiment of the present invention;

FIG. 4 is an exemplary block diagram showing a configuration of a server according to an exemplary embodiment of the present invention; and

FIG. 5 is an exemplary flowchart showing an operation flow of the system for controlling the vehicle according to the exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, exemplary embodiments of the present invention will be described with reference to the accompanying drawings.

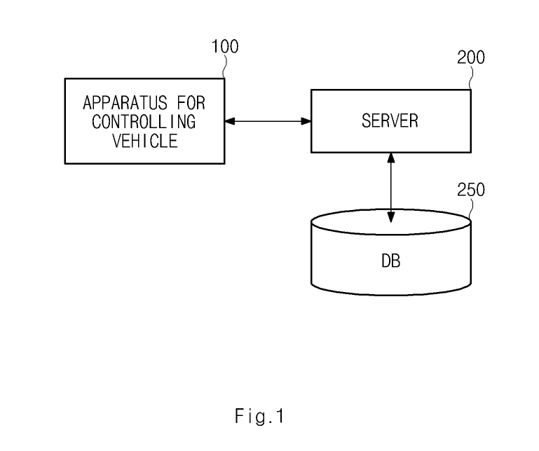

FIG. 1 is an exemplary diagram showing a configuration of a system for controlling a vehicle according to an exemplary embodiment of the present invention. Referring to FIG. 1, the system for controlling the vehicle may include an apparatus 100 for operating a vehicle and a server 200 disposed within the vehicle.

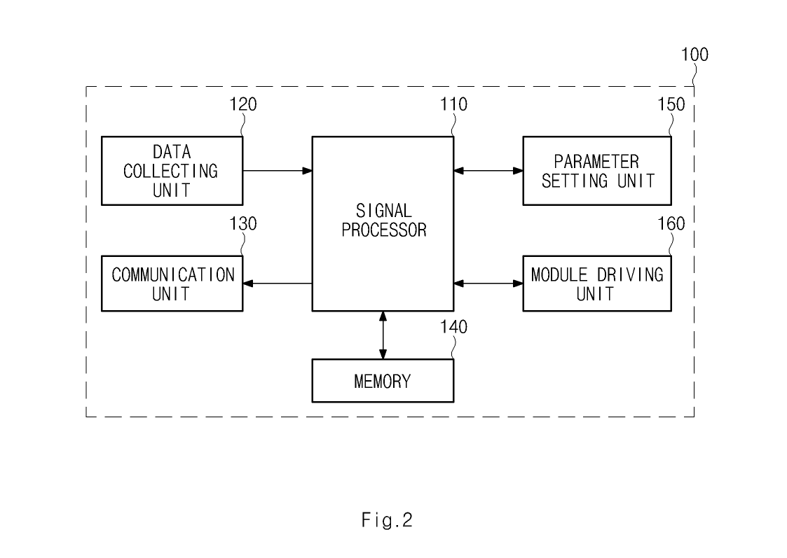

Specifically, the apparatus 100 may be configured to collect data regarding the vehicle and data regarding a surrounding environment of the vehicle from the vehicle to provide to the server 200, and receive control data from the server 200 when an event occurs to operate a driving of the vehicle based on the control data. Therefore, a configuration of the apparatus 100 will be described in more detail with reference to FIG. 2.

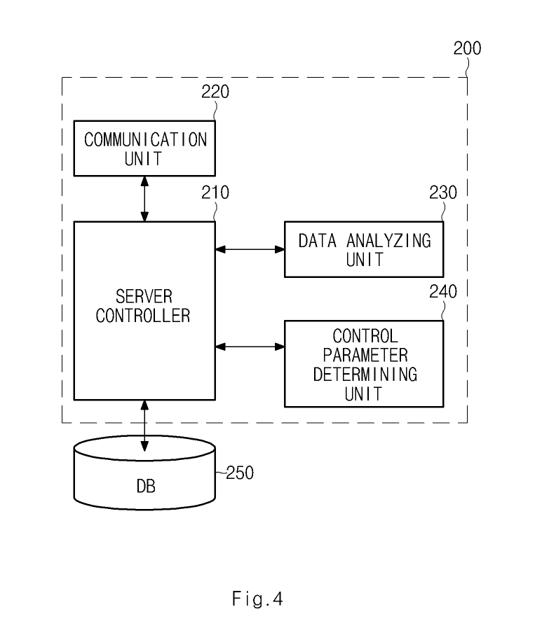

The server 200 may be configured to determine a driving pattern by receiving collected data from the apparatus 100 provided in a plurality of vehicles to store in a database (DB) 250, compare and analyze the stored collected data of the respective vehicles, and calculates particular statistics. In particular, the server 200 may be configured to digitize the driving pattern to manage the driving pattern, thereby making it possible to manage the driving pattern. However, the above is merely the exemplary embodiment of the present invention and the present invention is not limited to thereto. Therefore, a configuration of the server 200 will be described in more detail with reference to FIG. 4.

FIG. 2 is an exemplary block diagram showing a configuration of an apparatus for controlling a vehicle according to an exemplary embodiment of the present invention. Referring to FIG. 2, the apparatus 100 for operating the vehicle may include a signal processor 110 that executes a plurality of unites. The plurality of units may include a data collecting unit 120, a communication unit 130, a memory 140, a parameter setting unit 150, and a module driving unit 160. In particular, the signal processor 110 may be configured to process a signal according to an operation of each unit of the apparatus 100 to operate the vehicle.

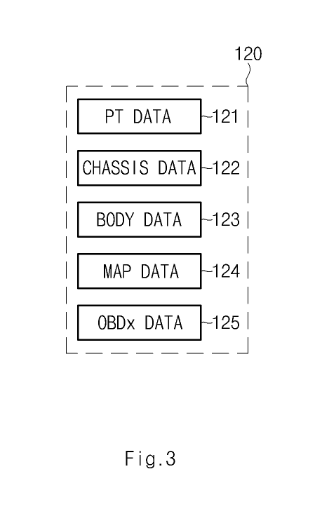

The data collecting unit 120 may be configured to collect multimedia vehicle information from the vehicle and the surrounding environment of the vehicle. In particular, the data collecting unit 120 may be configured to collect controller area network (CAN) data based on a vehicle manipulation and may be configured to collect sensor data via a sensor disposed within the vehicle. In addition, the data collecting unit 120 may be configured to collect map data via a navigation system or the like. A detailed operation of the data collecting unit 120 will be described in more detail with reference to FIG. 3.

The communication unit 130 may include a module that supports a communication interface for a transmission and a reception of a signal with the server. In particular, the communication unit 130 may be configured to transmit the collected data collected by the data collecting unit 120 to the server. Further, the communication unit 130 may be configured to transmit the collected data from the data collecting unit 120 to the server in real time and at a set time interval.

Moreover, when a control event occurs in a corresponding vehicle, the communication unit 130 may be configured to receive control data from the server and provide the received control data to the signal processor 110. In particular, the signal processor 110 may be configured to store the control data from the communication unit 130 in the memory 140 and transfer the control data to the parameter setting unit 150. The control data may include an operation mode degree to be controlled by the corresponding vehicle that corresponds to the driving pattern of the corresponding vehicle determined by the server based on the data collected from the vehicle or the surrounding environment of the vehicle and the control parameter value that corresponds to the corresponding operation mode.

Therefore, the parameter setting unit 150 may be configured to detect a control mode from the control data and set the control parameter value for the corresponding mode based on the control parameter value included in the control data, when the control data is input from the signal processor 110. In particular, the parameter setting unit 150 may be configured to change a basic setting value of the corresponding mode based on the control parameter value included in the control data, when the control data from the server is the control data of the mode which is not currently driven. Thereafter, when the vehicle is operated in the corresponding mode, the vehicle may be driven based on the changed basic setting value. In other words, the module driving unit 160 may be configured to drive the corresponding module based on the basic setting value set for the corresponding mode when the vehicle is operated in a specific mode. In particular, when the driving pattern of the driver driving the corresponding vehicle is changed, the driving of each module may be controlled based on the driving pattern changed when being operated in the corresponding mode by changing the basic setting values of the mode set for the corresponding vehicle.

Moreover, the parameter setting unit 150 may be configured to adjust a setting value of the corresponding module which is currently driven, based on the control parameter value included in the control data, when the control data from the server is the control data of the mode which is currently driven. The module driving unit 160 may be configured to reflect the setting value adjusted by the parameter setting unit 150 to thereby drive the corresponding module. In particular, when the vehicle is not driven in a normal driving pattern, but is driven in a pattern that deviates by a reference value or greater, the vehicle may be controlled to be driven in an original driving pattern by automatically changing the setting value of the driving module by the control data from the server.

FIG. 3 is an exemplary illustration diagram showing a detail configuration of a data collecting unit 120 of FIG. 2. Referring to FIG. 3, the data collecting unit 120 may be configured to collect map data, and may collect at least one of power train (PT) data, chassis data, body data, and on board diagnostics (OBD) data. In particular, the power train data, which is data regarding power transfer apparatus, corresponds to data collected from a transmission, a clutch, a shaft, an accelerator, an engine, a torque converter, and the like. The chassis data, which is data collected from the remaining units except for the body, corresponds to data collected from a fuel tank, a gear, a brake, a direction indicator, an air conditioning apparatus, a steering apparatus, a sensor, and the like. The body data, which is data collected from the body, may be data collected from a wheel, a bumper, a panel, and the like. In addition, the map data may be collected via the navigation system of the vehicle, or the like and the map data may include coordinate information and surrounding environment information. The on board diagnostics data corresponds to data collected by a diagnostics algorithm of the vehicle.

FIG. 4 is an exemplary block diagram showing a configuration of a server according to an exemplary embodiment of the present invention. Referring to FIG. 4, the server 200 may include a server controller 210 configured to execute a plurality of units. The plurality of units may include a communication unit 220, a data analyzing unit 230, a control parameter determining unit 240, and a database (DB) 250.

The communication unit 220 may include a module that supports a communication interface for a transmission and a reception of the signal with the apparatus disposed within the vehicle. In particular, the communication unit 220 may be configured to receive the data collected from the vehicle and the surrounding environment of the vehicle from the apparatus for controlling the vehicle. The collected data received by the communication unit 220 may be transferred to the server controller 210. Further, the server controller 210 may be configured to store the collected data received via the communication unit 220 in the DB 250. Specifically, the DB 250 may be configured to store the collected data input from the server controller 210. In addition, each collected data divided into each vehicle or each driver may be stored in the DB 250.

Furthermore, the server controller 210 may be configured to transfer the collected data to the data analyzing unit 230. In particular, the data analyzing unit 230 may be configured to analyze the input collected data to determine the driving pattern for the corresponding vehicle. The data analyzing unit 230 may be configured to compare the collected data of the corresponding vehicle with collected data received from other vehicles and calculate statistics, thereby making it possible to digitalize the driving pattern of a user.

As an example, the data analyzing unit 230 may be configured to compare the collected data of the corresponding vehicle with an accel position sensor (APS), an average speed, an average acceleration, a steering angle sensor (SAS), and the like among the collected data received from other vehicles to calculate whether a sporty degree of the driving pattern of the corresponding vehicle corresponds to a percentage of a highest sporty degree of the driving pattern, thereby making it possible to digitalize the driving pattern. In particular, the data analyzing unit 230 may be configured to divide the sporty degree of the driving pattern into 1 to 10 and compare the collected data of the corresponding vehicle with the collected data received from other vehicles, thereby making it possible to determine whether the sporty degree of the driving pattern of the corresponding vehicle corresponds to any degree of 1 to 10.

As another example, the data analyzing unit 230 may be configured to collect a control value for the air conditioning apparatus in real time to thereby determine an air conditioning control pattern for the corresponding vehicle. Of course, this is merely the exemplary embodiment of the present invention and the present invention is not limited to thereto, and the method for managing the driving pattern of each vehicle may be variously applied. In particular, the control parameter determining unit 240 may be configured to determine the control parameter value that corresponds to the driving pattern of the corresponding vehicle determined from the data analyzing unit 230.

Moreover, the server controller 210 may be configured to determine whether the control event for the corresponding vehicle occurs while the collected data is received via the communication unit 220 in real time. As an example, the server controller 210 may be configured to compare the driving pattern determined for the corresponding vehicle with the driving pattern determined by the data collected in real time and determine whether the driving pattern of a current vehicle is deviated from a pre-registered driving pattern by the reference value or greater, thereby making it possible to determine whether the control event occurs.

In response to determining that the driving pattern of a current vehicle is deviated from the driving pattern of the corresponding vehicle by the reference value or greater, the server controller 210 may be configured to provide the control data including the control parameter value determined by the control parameter determining unit 240 in a mode which is currently operated by the apparatus for controlling the vehicle of the corresponding vehicle via the communication unit 220 to operate the corresponding vehicle based on an existing driving pattern. Therefore, the apparatus for controlling the vehicle may change the basic setting value of the corresponding mode based on the control parameter value from the server 200.

In addition, the server controller 210 may be configured to determine whether the control event occurs by detecting whether the pre-determined driving pattern is changed from the reference value by the analyzed result of the collected data. In particular, when the driving pattern of the corresponding vehicle is changed, the server controller 210 may be configured to provide the control data including the control parameter value determined by the control parameter determining unit 240 to the apparatus for controlling the vehicle of the corresponding vehicle via the communication unit 220 to change each mode of the corresponding vehicle to the control parameter value that corresponds to the changed driving pattern. Therefore, the apparatus for controlling the vehicle may adjust the setting value of the module which is currently driven based on the control parameter value from the server 200.

An operation flow of the system for controlling the vehicle according to the exemplary embodiment of the present invention configured as described above will be described below in detail.

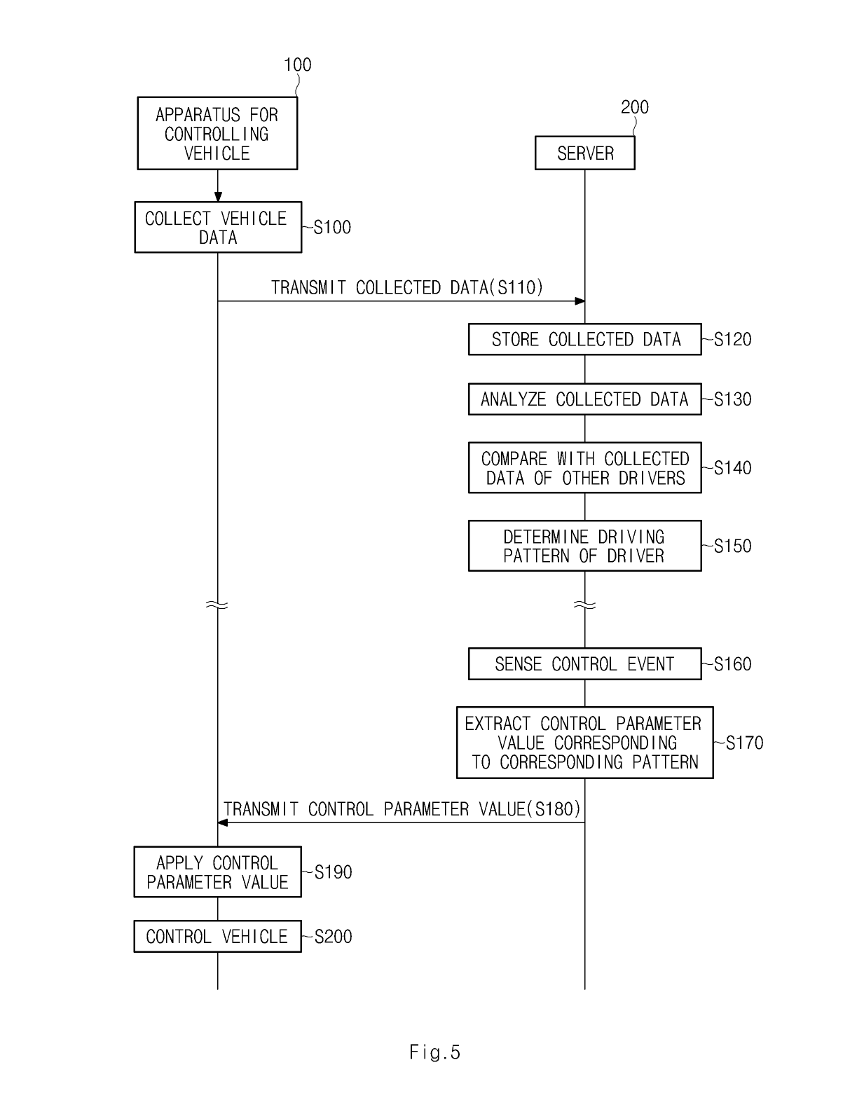

FIG. 5 is an exemplary flowchart showing an operation flow of the system for controlling the vehicle according to the exemplary embodiment of the present invention. As shown in FIG. 5, the apparatus 100 for controlling the vehicle may be configured to collect the vehicle data (S100) to transmit to the server 200 (S110). In particular, the apparatus 100 for controlling the vehicle may be configured to transmit the collected data in real time when the data is collected in ‘S100’ process, and may be configured to transmit the collected data at a defined time period according to the setting.

In addition, the server 200 may be configured to store the collected data received from the ‘S110’ process in the DB (S120) and analyze the corresponding collected data (S130) to compare with the collected data for other drivers, that is, other vehicles (S140). The server 200 may be configured to digitalize the driving pattern of the corresponding driver, that is, the corresponding vehicle into a relative value for the driving pattern of other vehicles based on the result of the ‘S140’ process (S150). For example, the sporty degree of the driving pattern may be digitalized. The ‘S100’ to ‘S150’ processes may be repetitively performed during the driving of the vehicle.

Moreover, the server 200 may be configured to determine whether the control event occurs based on the analyzed result of the collected data from the apparatus 100. When an occurrence of the control event is sensed (S160), the server 200 may be configured to extract the control parameter value that corresponds to the driving pattern determined for the corresponding vehicle (S170) to transmit to the apparatus 100 disposed within the corresponding vehicle (S180). Next, the apparatus 100 for controlling the vehicle may be configured to apply the control parameter value received from the ‘S180’ process to the setting value for the module of the corresponding mode (S190) and may be configured to operate the vehicle according to the set value in the ‘S190’ process (S200).

According to the exemplary embodiment of the present invention, significant data for the data collected from each vehicle may be managed by analyzing and managing the collected data of the vehicle in the server. In addition, according to the exemplary embodiment of the present invention, the vehicle control may be rapidly processed by extracting and providing the control parameter value that corresponds to the driving pattern of the corresponding vehicle from the server when the control event occurs in the corresponding vehicle.

Although the apparatus and method for controlling the vehicle according to the exemplary embodiment of the present invention have been described with reference to the accompanying drawings, the present invention is not limited to the exemplary embodiment and the accompanying drawings disclosed in the present specification, but may be modified without departing from the scope and spirit of the present invention.

What is claimed is:

1. An apparatus for controlling a vehicle, comprising:
a controller includes a memory and a processor, the memory configured to store program instructions and the processor configured to execute the program instructions, the program instructions when executed configured to:
collect data from the vehicle and a surrounding environment of the vehicle;
transmit the collected data to a server;
receive, from the server, control data that corresponds to a driving pattern generated based on the collected data when a control event occurs;
set a control parameter value for a corresponding mode of the vehicle based on the control data; and
operate a module driving of the vehicle based on the control parameter value.

2. The apparatus for controlling a vehicle according to claim 1, wherein the control data includes information regarding an operation mode and the control parameter value that corresponds to the operation mode.

3. The apparatus for controlling a vehicle according to claim 2, wherein the program instructions when executed are further configured to:
change a basic setting value of a corresponding mode based on the control parameter value included in the control data, when the control data is control data of a mode which is not currently driven.

4. The apparatus for controlling a vehicle according to claim 2, wherein the program instructions when executed are further configured to:
adjust a setting value of a module which is currently driven based on the control parameter value included in the control data, when the control data is control data of a mode which is currently driven.

5. The apparatus for controlling a vehicle according to claim 1, the collected data is multimedia vehicle information that includes map data and at least one of controller area network (CAN) data and sensor data of the vehicle.

6. A system for controlling a vehicle, comprising:
a server, executed by a controller to:
analyze data collected from a vehicle during driving in real time to manage a driving pattern for the vehicle; and
provide to the vehicle control data that corresponds to the driving pattern of the vehicle when a control event for the vehicle occurs to set a control parameter value of the vehicle based on the control data and operate a driving of the vehicle according to the set control parameter value.

7. The system for controlling a vehicle according to claim 6, wherein the server is further configured to:
analyze the collected data from the vehicle to determine a driving pattern for the corresponding vehicle;
determine a control parameter value that corresponds to the driving pattern;
compare the collected data of the vehicle with the driving pattern determined for the corresponding vehicle to determine whether a control event occurs; and
provide the control data including the control parameter value to the vehicle when the control event for the vehicle occurs.

8. The system for controlling a vehicle according to claim 7, wherein the server is configured to provide the control parameter value that corresponds to a changed driving pattern of a corresponding mode to the vehicle when a driving pattern of a specific mode for the vehicle is changed as a result of analyzing the collected data.

9. The system for controlling a vehicle according to claim 8, wherein a basic setting value of the corresponding mode is changed based on the control parameter value.

10. The system for controlling a vehicle according to claim 7, wherein the server is configured to provide the control parameter value that corresponds to the driving pattern to the vehicle to operate the vehicle when a current control pattern of the vehicle is deviated from the driving pattern of the vehicle by a reference value or greater.

11. The system for controlling a vehicle according to claim 10, wherein a setting value of a module which is currently driven is adjusted based on the control parameter value.

12. A method for controlling a vehicle, comprising:
collecting, by a controller, data from the vehicle and a surrounding environment of the vehicle;
transmitting, by the controller, the collected data to a server;
receiving, by the controller, control data that corresponds to a driving pattern generated based on the collected data when a control event occurs;
setting, by the controller, a control parameter value for a corresponding mode of the vehicle based on the control data; and
operating, by the controller, a module driving of the vehicle based on the control parameter value.

13. The method for controlling a vehicle according to claim 12, wherein the control data includes information regarding an operation mode and the control parameter value that corresponds to the operation mode.

14. The method for controlling a vehicle according to claim 13, further comprising:
changing, by the controller, a basic setting value of a corresponding mode based on the control parameter value included in the control data, when the control data is control data of a mode which is not currently driven.

15. The method for controlling a vehicle according to claim 13, further comprising:
adjusting, by the controller, a setting value of a module which is currently driven based on the control parameter value included in the control data, when the control data is control data of a mode which is currently driven.

16. A non-transitory computer readable medium containing program instructions executed by a controller, the computer readable medium comprising:
program instructions that collect data from the vehicle and a surrounding environment of the vehicle;
program instructions that transmit the collected data to a server;
program instructions that receive control data that corresponds to a driving pattern generated based on the collected data when a control event occurs;
program instructions that set a control parameter value for a corresponding mode of the vehicle based on the control data; and
program instructions that operate a module driving of the vehicle based on the control parameter value.

17. The non-transitory computer readable medium of claim 16, wherein the control data includes information regarding an operation mode and the control parameter value that corresponds to the operation mode.

18. The non-transitory computer readable medium of claim 17, further comprising:
changing, by the controller, a basic setting value of a corresponding mode based on the control parameter value included in the control data, when the control data is control data of a mode which is not currently driven.

19. The non-transitory computer readable medium of claim 17, further comprising:
program instructions that adjust a setting value of a module which is currently driven based on the control parameter value included in the control data, when the control data is control data of a mode which is currently driven.
